(19) United States
(12) Patent Application Publication
(10) Pub. No.: US 2005/0141608 A1
(43) Pub. Date: Jun. 30, 2005

(54) Pipeline-type operation method for a video processing apparatus and bit rate control method using the same

(75) Inventors: Dae-Kyu Shin, Seoul (KR); Seung-Cheol Lee, Yongin-si (KR); Ji-Ho Park, Seoul (KR); Hyun-Seung Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/936,187

(22) Filed: Sep. 8, 2004

(30) Foreign Application Priority Data
Dec. 31, 2003 (KR) 101714-2003

(51) Int. Cl. H04N 7/12

(52) U.S. Cl. 375/240.03; 375/240.23; 375/240.2

(57) ABSTRACT

Disclosed is a pipeline-type operation method which can reduce idle operations of hardware modules. The pipeline-type operation method for a video processing apparatus including a plurality of hardware modules includes the steps of constructing a plurality of hardware modules according to functions required to process video; arranging the hardware modules according to a sequence of input data flow, and inputting a first predetermined unit of data into a first hardware module from among the arranged hardware modules; transferring processed data from the first hardware module to a second hardware module when the predetermined unit of data inputted into the first hardware module has been processed, and receiving a next predetermined unit of data; repeating the transferring and receiving steps, in which each input data are processed by the hardware modules according to a sequence of the hardware modules, until all of the hardware modules are operated; ions receiving and processing data processed in a previous step by the previous hardware module in a sequence of data flow by each of the hardware modules; and repeating the receiving and processing steps until no predetermined unit data to be inputted remains.

### PRIORITY

This application claims priority to an application entitled “Pipeline-Type Operation Method Of Video Processing Apparatus And Bit Rate Control Method Using The Same” filed in the Korean Intellectual Office on Dec. 31, 2003 and assigned Serial No. 2003-101714, the contents of which are incorporated herein by reference.

### BACKGROUND OF THE INVENTION

1. Field of the Invention

The present invention relates to a multimedia data service in a mobile communication terminal, and more particularly to a video encoder/decoder using a discrete cosine transform (DCT).

2. Description of the Related Art

In a mobile communication terminal capable of a two-way moving image communication, a video encoder controls a bit rate to enable the terminal to perform the communication at a fixed bit rate. Currently, the 3GPP (Third Generation Partnership Project) and the domestic mobile communication providers have prepared standards for and recommend the use of H.263 and MPEG (Motion Picture Experts Group) 4 as encoders for a moving image. Since the compression principle of such standard video encoders is based on a discrete cosine transform (hereinafter, referred to as ‘DCT’) and motion estimation (hereinafter, referred to as ‘ME’), a compression ratio changes according to the characteristics of the moving images. However, it is very difficult to realize a technique for promptly controlling bit rates according to the changing compression ratios. Therefore, the standards have specifications recommending a scheme capable of controlling the compression ratio of a moving image by changing a quantization value in a quantizing step.

FIG. 1 is a block diagram showing a construction of an example of a conventional H.263/MPEG video encoder.

As shown in FIG. 1, a conventional H.263/MPEG video encoder includes an original image storage unit 101, a first switch 103, a DCT unit 104, a quantization (Q) unit 105, an inverse quantization (IQ) unit 106, an inverse discrete cosine transform (hereinafter, referred to as ‘IDCT’) unit 107, a coupler 110, a recon storage unit (recon memory) 111, a motion estimation (hereinafter, referred to as ‘ME’) unit 112, a motion compensation (hereinafter, referred to as ‘MC’) unit 113, an Mced storage unit (Mced memory) 114, a quantization parameter (QP) storage unit 116, an ODTQ storage unit 108, and a variable length coding (hereinafter, referred to as ‘VLC’) unit 109. The original image storage unit 101 receives the image information in frame units and stores the received moving image. The first switch 103 transmits a first frame of the image information from the original image storage unit 101 directly to the DCT unit 104, and transmits the other frames of the image information from the original image storage unit 101 indirectly to the DCT unit 104 through an operation 102 with motion-compensated information which is stored in the Mced storage unit 114. The DCT unit 104 performs a discrete cosine transform. The quantization (Q) unit 105 quantizes the output of the DCT unit 104. The inverse quantization (IQ) unit 106 inverse-quantizes quantized data. The IDCT unit 107 performs an inverse discrete cosine transform for the output of the inverse quantization unit 106. The coupler 110 couples the motion-compensated information of a previous fame (n−1) stored in the Mced storage unit 114 and decoding information of a current frame (n) decoded by the IDCT unit 107. The recon storage unit 111 stores decoding information for the current frame (n). The ME unit 112 receives the decoding information of a previous frame (n−1) stored in the recon storage unit 111 and an original image of a current frame (n), and then outputs a differential image and a motion vector for the motion estimation. The MC unit 113 receives the output of the ME unit 112 and decoding information of a previous frame (n−1) stored in the recon storage unit 111 and compensates the motion of the decoding information of the previous frame. The Mced storage unit 114 stores information of a previous frame (n−1) which has been motion-compensated. The QP storage unit 116 transmits quantization values for controlling a bit rate to the quantization unit 105, which are different according to whether the input image information is ‘Intra’, ‘Inter’, or ‘Skipped’. The ODTQ storage unit 108 stores data encoded by the quantization unit 105. The VLC unit 109 performs an entropy coding to assign lower bit rates to more-frequently appearing values and to assign higher bit rates to less-frequently appearing values.

In the construction described above, when a quantization value is determined in the quantization unit 105, all values less than the determined quantization value become ‘0’. That is, the quantization values are maintained within a predetermined range, and each of coefficients in the discrete-cosine-transformed blocks is divided by a quantization value, so that a quotient is obtained. When the quantization value is large, the obtained quotient has a large error, so that image quality deteriorates but compression effect is improved. In contrast, when the quantization value is small, the obtained quotient has a small error, so that image quality does not deteriorate but compression effect is reduced. Accordingly, it is necessary to determine the quantization values and the range of the coefficients to increase quality and improve compression effect.

Also, when taking into consideration of the output of the video encoder shown in FIG. 1 in which encoded video data is output in H.263 bit streams, in order to control bit rates according to the H.263 CODEC standard, the difference between an encoded bit rate and an assigned bit rate of a predetermined bandwidth is calculated while the encoding is performed by the macroblock or more, and then a quantization value increases or decreases according to the calculated difference.

Such a conventional video encoder needs to compress a huge amount of data in order to process the video data. Therefore, the conventional video encoder uses the MPEG (Moving Picture Experts Group) standard image compression techniques of an H.26X series, or the standard still image compression techniques such as JPEG (Joint Photographic Experts Group). As the image compression algorithms become more and more complicated, the performances are improved, but it becomes proportionally more difficult to process the video data by using only software.

Therefore, hardware modules have been used for processing the video data, especially, portions—for example, ME, MC, and DCT—including many operations have been often constructed as hardware modules.

FIG. 2 is a block diagram showing a construction of an example of a conventional video encoder having modularized hardware.

In the following description, the modularized video encoder shown in FIG. 2 will be explained in comparison with a conventional video encoder shown in FIG. 1.

In the algorithms used in a video codec, certain portions that require many operations become the portions for the ME, the MC, the DCT/Q (discrete cosine transform and quantization), and the IDCT/Q (inverse discrete cosine transform and inverse quantization). In a wireless terminal, when such portions can be processed by software, it is unnecessary to use hardware for such portions.

However, although such portions can be processed by software in the case of a video decoder, it is difficult to process these portions by software in the case of a video encoder, and it is almost impossible to obtain a satisfactory result when it is realized. Therefore, such portions requiring many operations have been realized by using hardware modules. In this case, the functions of the ME, the MC, and the DCT are sequentially processed to realize these functions.

Referring to FIG. 2, the conventional video encoder includes an ME module 201 for estimating a motion between inter-frames, an MC module 202 for compensating for a motion by using a motion-estimated value and a reconstructed image 207 which is a previous result value, a DCT module 203 for performing a discrete cosine transform using a motion-compensated result value, and a VLC module 206 for performing an entropy coding for the control of the bit rate.

The ME module 201 outputs a motion-estimated value and a motion vector (MV) 208. The DCT module 203 includes a DCT processing unit 204 for encoding and an IDCT processing unit 205 for decoding the encoded value so as to be used when the next input data is processed.

That is, the operations of the respective hardware modules are as follows. First, the ME module 201 extracts a motion vector (MV) 208. The ME module 201 divides an image to be configured into predetermined sizes in advance, compares pixels with each other from a corresponding position of a previous frame until finding a position most adjacent to a corresponding block in a searching region, and stores a motion vector 208 obtained through the comparison.

The MC module 202 obtains a corresponding region using the motion vector 208, thereby creating—copying and interpolating—a reconstructed image 207. That is, the data of a block located at a position corresponding to the motion vector 208 estimated through the motion estimation are brought from an image (reconstructed image 207) reproduced by the previous decoding process.

Herein, when the motion vector 208 has an integer unit, it may be performed without any problem to bring the block data of a corresponding position and to reproduce an image. In contrast, when the motion vector 208 has a half-pixel unit, it is necessary to reconstruct an image through interpolation. As a result, a great number of operations are required, so that it may be highly required to modularize hardware of a video processing apparatus.

The DCT module 203 creates a new image by performing DCT/Q and IDCT/IQ for the image difference between the reconstructed image 207 and a current image, and then adds the created image to the reconstructed image 207, thereby creating a final reconstructed image 207.

FIG. 3 is a diagram for illustrating an example of a general process by a conventional video encoder having modularized hardware.

Referring to FIG. 3, in the case of processing input image blocks by the GOB (group of blocks), the MC module 202 can start its operation after the operation of the ME module 201 has been completed, and the DCT module 203 can start its operation after the operation of the MC module 202 has been completed.

Consequently, while one module operates, other modules are maintained in an idle state.

Also, since a software portion can operate after the operations of the hardware modules 201, 202, and 203 have been completed, it can be understood that the software portion is maintained in an idle state during the operations of the hardware modules 201, 202, and 203.

To be more specific, FIG. 3 shows a process according to the passage of time, for each of a hardware portion 31, a software portion 32, and processing blocks 33, which are divided from each other. First, the ME 201, the MC 202, and the DCT 203 is sequentially performed for a GOB 0 301 which is a first processing group of blocks. At this time, the software portion 32 is maintained in an idle state 304. When the DCT 203 has been processed for the GOB 0 301, the hardware portion 31 goes into an idle state, and an operation 305 of the software portion 32 is performed. When the operation of the software portion 32 has been completed, a GOB 1 302, which is the next processing group of blocks, is input, and then the respective operations of the hardware and software portions are performed.

With the video processing apparatus having modularized hardware as described above, even though portions including many operations in a video codec are modularized as hardware, it is impossible to obtain a satisfactory performance through the sequential processing of the hardware modules as shown in FIG. 3 when a complicated operation of simultaneously operating an encoder and a decoder such as in a video conference is required.

That is, in the case of sequentially processing the hardware modules, while any one module (for example, the ME module) operates, the remaining modules (for example, the MC module and the DCT module) are maintained in an idle state, and a central processing unit (CPU) for processing the software portion 32 is also maintained in an idle state for this period of time because the CPU uses a resultant obtained through the operations of the modules, so that there is an efficiency problem.

In addition, in order to perform a bit rate control for controlling a generation bit rate of the video data, the ME, the MC, the DCT, the VLC, etc., are sequentially processed according to the processing blocks. That is, when one processing unit has been completely processed, an amount of following bits to be generated is determined according to an amount of bits in the processed unit. As described above, after an operation for one processing block has been processed, parameters of the next processing block are determined.

As the parameters, the quantization values usually applied to a DCT coefficient are mainly used, although such quantization values may restrict a DCT coefficient receiving assignment of the bits. Consequently, when it is determined that the amount of the generated bits is large, the quantization value is set to a large value to reduce the number of coefficients for the bit assignment, thereby decreasing the amount of the bits for the next processing unit. In contrast, when it is determined that the amount of the generated bits is small, the quantization value is set as a small value to increase the number of the coefficients for the bit assignment, thereby increasing the amount of bits for the next processing unit.

As describe above, in the case of including the VLC hardware module for the bit rate control, each processing group of blocks (GOB) undergoes the processes of ME, MC, DCT, and VLC. While one hardware module operates, the remaining modules are maintained in an idle state, and also the operation of the software portion is maintained in an idle state, so that there are problems in that the processing time of the respective video data increases and resources are inefficiently used.

### SUMMARY OF THE INVENTION

Accordingly, the present invention has been made to solve at least the above-mentioned problems occurring in the prior art, and an object of the present invention is to provide a pipeline-type operation method for a video processing apparatus including hardware modules according to functions, in which data is processed by hardware modules operated in parallel to each other instead of being processed by the operation unit, so that the pipeline-type operation method can reduce idle operations of hardware modules.

Also, another object of the present invention is to provide a method for controlling a bit rate control method, which uses an SAD (Sum of Absolute Difference) of an operation unit in order to control the bit rate through the control of a quantization value which may cause a problem in operation of a pipeline-type operation structure.

To accomplish this object, in accordance with one aspect of the present invention, there is provided a pipeline-type operation method for a video processing apparatus including a plurality of hardware modules, the pipeline-type operation method including the steps of constructing a plurality of hardware modules according to functions required in a video processing course; arranging the hardware modules, which have been constructed according to the functions in step 1, according to a sequence of input data flow, and inputting first predetermined unit data into a first hardware module from among the arranged hardware modules; transferring processed data from the first hardware module to a second hardware module when the predetermined unit data input into the first hardware module have been processed, and receiving next predetermined unit data; repeating step 3, in which each input data are processed by the hardware modules according to a sequence of the hardware modules, until all of the hardware modules are operated; each of the hardware modules according to the functions receiving and processing data processed in the previous step by the previous hardware module in a sequence of data flow; and repeating step 5 until no predetermined unit data to be input remains.

In accordance with another aspect of the present invention, there is provided a method for controlling a bit rate in a video processing apparatus which includes a plurality of hardware modules including a variable length coding (VLC) module and has a pipeline-type operation structure, the method comprising the steps of independently operating each of the hardware modules including the VLC module in the pipeline-type structure, transferring a coding result of the predetermined unit data second prior to data in a specific sequence into the VLC module so that the VLC module decides a quantization value for current predetermined unit data which are wanted to be coded in the specific sequence; and deciding a quantization value required for coding by means of a coding result transferred in step 2, and transferring the determined quantization value to a coding course for predetermined unit data second next to the data in the specific sequence.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing an example of a conventional H.263/MPEG video encoder;

FIG. 2 is a block diagram showing an example of a conventional video encoder having modularized hardware;

FIG. 3 is a diagram illustrating a general operation process of a conventional video encoder having modularized hardware;

FIG. 4 is a diagram illustrating a first embodiment of a process by a video encoder having modularized hardware, which operates in a pipeline-type operation structure according to the present invention;

FIG. 5 is a diagram illustrating a second embodiment of a process by a video encoder having modularized hardware, which operates in a pipeline-type operation structure according to the present invention;

FIG. 6 is a diagram illustrating an embodiment of a process by the video encoder of FIG. 4 including a bit rate control module in addition to the pipeline-type operation structure;

FIG. 7 is a diagram illustrating an embodiment of a process by a video encoder having modularized hardware, which includes a VLC module and operates in a pipeline-type operation structure according to the present invention;

FIG. 8 is a diagram illustrating a process of a pipeline-type operation structure for transferring control values between a DCT module and a VLC module according to the present invention; and

FIGS. 9A and 9B are flowcharts showing an embodiment of an encoding method for a video encoder having a pipeline-type operation structure according to the present invention.

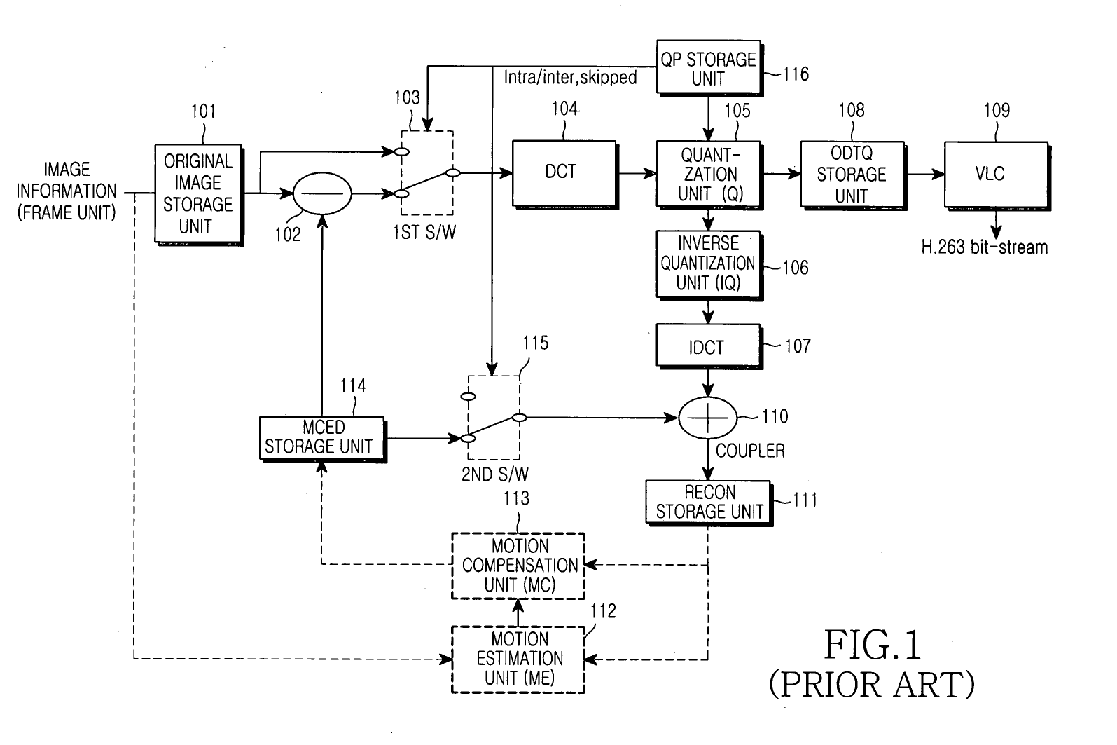

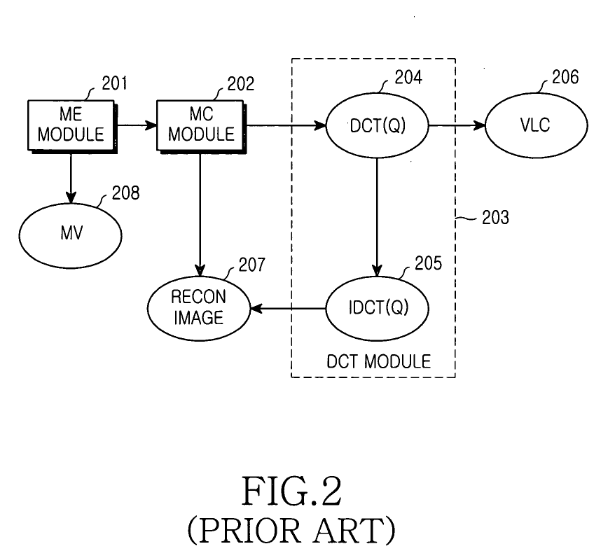

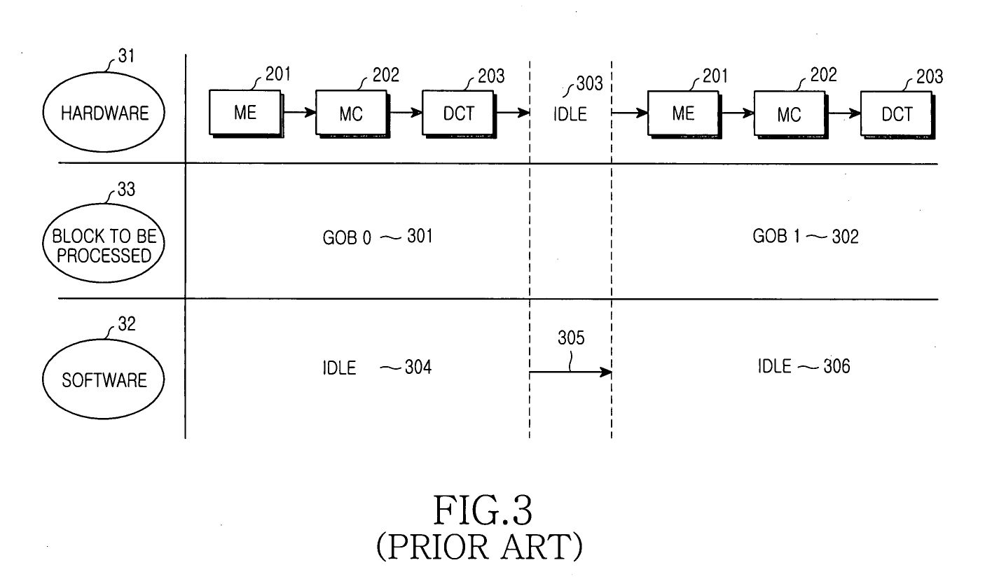

### DETAILED DESCRIPTION OF THE PREFERRED EMBODIMENT

Hereinafter, preferred embodiments of a pipeline-type operation method of a video processing apparatus and a bit rate control method using the same according to the present invention will be described with reference to the accompanying drawings. In the following description of the present invention, a detailed description of known functions and configurations incorporated herein will be omitted when it may obscure the subject matter of the present invention.

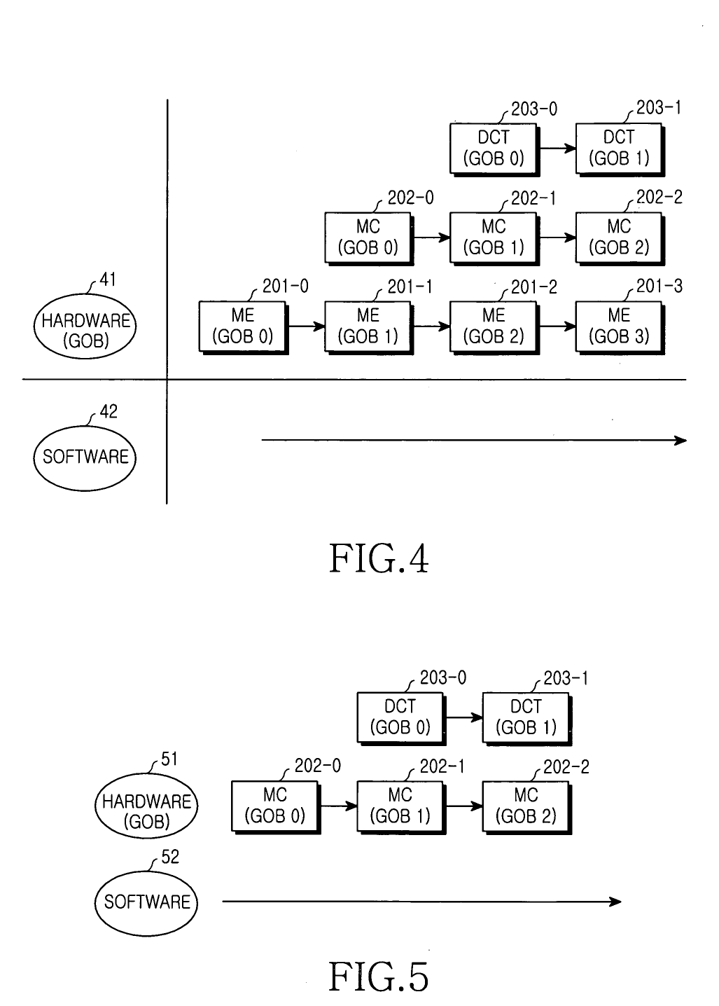

FIG. 4 is a diagram illustrating a first embodiment of a process for a video encoder having modularized hardware, which operates in a pipeline-type operation structure according to the present invention.

As shown in FIG. 4, in a video encoder having modularized hardware which operates in a pipeline-type operation structure according to the present invention, each hardware module of ME, MC, and DCT is continuously processed. That is, in the method according to the present invention also, when an operation of one hardware module has been processed, a result of the processing is used to process an operation of the next hardware module, similar to the conventional method. Moreover, the method according to the present invention permits hardware modules to independently perform their own operations, which is different from the conventional method which does not permit simultaneous operations of more than one hardware module.

In the following description, the present invention will be explained in more detail with reference to FIG. 4.

First, an ME operation 201-0 is performed for a GOB 0. Next, an ME operation 201-1 is performed for a GOB 1. At this time, an MC operation 202-0 using the resultant obtained from the ME operation for the GOB 0 is performed simultaneously with the ME operation for the GOB 1. Subsequently, an ME operation 201-2 is performed for a GOB 2. At this time, both an MC operation 202-1 using the resultant obtained from the ME operation for the GOB 1 and a DCT operation 203-0 for the GOB 0 using the resultant obtained from the MC operation for the GOB 0 are performed simultaneously with the ME operation for the GOB 2.

After this, an ME operation 201-N for a GOB N, an MC operation 202-(N−1) for a GOB (N−1), and a DCT operation 203-(N−2) for a GOB (N−2) are simultaneously performed.

As described above, since the operations of the hardware modules are performed in a parallel structure, a processing time is determined as the period of time (for example, T₁) which is the longest among the periods of time for the respective operations of the hardware modules (ME, MC, and DCT) when the respective processing times of the hardware modules for one GOB are T₁, T₂, and T₃, respectively. This length of time is quite difference from ‘T₁+T₂+T₃’, which is the conventional period of time.

In order to perform such a parallel operation, when data to be input exist, each hardware module processes input data and then transfers the processed data into a next hardware module. Such data is input into the hardware modules in a unit of a GOB with a processing time period for the ME module which requires the longest period of time from among the hardware modules, so that the hardware modules can parallel process data of a GOB unit input with a processing time period for the ME module.

Therefore, the ME module requests the input of the GOB data according to a processing state of the data. With the remaining modules except for the ME module, when data to be input into the remaining modules exists, each of the remaining modules determines whether or not data being processed exists. As a result of the determination, when there exists data being processed, a corresponding module from among the remaining modules buffers the input data until the data being processed has been completely processed. In contrast, when there is no data being processed, the corresponding module from among the remaining modules processes the input data.

FIG. 5 is a diagram illustrating a second embodiment of a process by a video encoder having modularized hardware, which operates in a pipeline-type operation structure according to the present invention.

FIG. 5 shows an embodiment of a case in which only two function blocks, MC and DCT, are constructed as hardware blocks. In the following description, the operation of a video encoder having two hardware blocks will be explained in detail with reference to FIG. 5.

First, an MC operation 202-0 is performed for a GOB 0. Next, an MC operation 202-1 is performed for a GOB 1. At this time, a DCT operation 203-0 using the resultant obtained from the MC operation for the GOB 0 is performed simultaneously with the MC operation for the GOB 1. Subsequently, an MC operation 202-2 is performed for a GOB 2. At this time, a DCT operation 203-1 using the resultant obtained from the MC operation for the GOB 1 is simultaneously performed.

After this, an MC operation 202-N for a GOB N, and a DCT operation 203-(N−1) for a GOB (N−1) are simultaneously performed.

As described above, since the operations of the hardware modules are performed in a parallel structure, a processing time is determined as the period of time (for example, T₂) being longest between the periods of time for the respective operations of the hardware modules (MC and DCT) when the respective processing times of the hardware modules for one GOB are T₂ and T₃, respectively. This length of time is quite difference from ‘T₂+T₃’, which is the conventional period of time.

As described above, likewise also in the case of a video encoder constructed with two hardware modules, the operations of the hardware modules can be performed in a pipeline-type operation structure. In addition, the hardware modules and the software can operate in a pipeline-type operation structure. That is, the operation of the software may be regarded as the operation of the hardware module, so that it is possible to realize their operations in a pipeline-type operation structure.

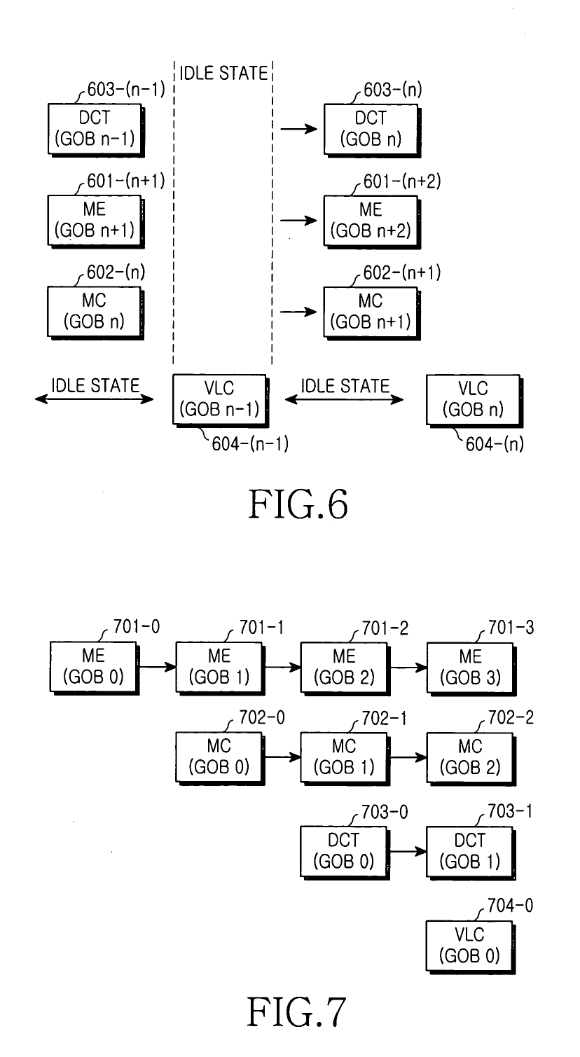

FIG. 6 is a diagram illustrating an embodiment of a process for the video encoder of FIG. 4 including a bit rate control module in addition to the pipeline-type operation structure.

As shown in FIG. 6, in the case in which a variable length coding (hereinafter, referred to as ‘VLC’) module for controlling a bit rate is included in the video encoder having a pipeline-type operation structure shown in FIG. 4, the hardware modules for the ME, the MC, and the DCT can operate in a pipeline-type operation structure as shown in FIG. 4, but there is a problem with respect to the hardware module for the VLC.

The VLC module calculates a bit rate of a current GOB and decides a quantization value Q used when the DCT module processes the next GOB by using the result of the calculation. Therefore, the operation of the VLC module must start after the operation of the DCT module for a current GOB has been completed, and the operation of the DCT module for the next GOB can be performed after the operation of the VLC module for the current GOB has been completed. That is, there is no alternative but to use an operation structure as shown in FIG. 6.

Referring to the operation structure shown in FIG. 6, an ME operation 601-(n+1) for a GOB (n+1), an MC operation 602-(n) for a GOB n, and a DCT operation 603-(n−1) for a GOB (n−1) are simultaneously performed, and, during these operations, the VLC module is maintained in an idle state. When the ME operation 601-(n+1), the MC operation 602-(n), and the DCT operation 603-(n−1) have been completed, a VLC operation 604-(n−1) for the GOB (n−1) starts. Herein, a first portion for the ME operation 601-(n+1), the MC operation 602-(n), and the DCT operation 603-(n−1), and a second portion for the VLC operation 604-(n−1) alternates with each other, thereby having an idle state alternating.

Herein, similar to the case of the conventional video encoder, a unnecessary idle state often occurs, so that there is a problem in that resources of hardware modules are wasted.

FIG. 7 is a diagram illustrating an embodiment of a process for a video encoder having modularized hardware, which includes a VLC module and operates in a pipeline-type operation structure according to the present invention.

As shown in FIG. 7, in a video encoder having modularized hardware which includes a VLC module and operates in a pipeline-type operation structure according to the present invention, the respective hardware modules for the ME, the MC, the DCT, and the VLC operate continuously. That is, in the method according to the present invention, when an operation of one hardware module has been processed, a result of the processing is used to process an operation of the next hardware module, similar to the conventional method. Moreover, the method according to the present invention permits hardware modules to independently perform their own operations, which is different from the conventional method which does not permit the simultaneous operations of more than one hardware module.

In the following description, the operation of a video decoder will be explained in detail with reference to FIG. 7.

First, an ME operation 701-0 is performed for a GOB 0. Next, an ME operation 701-1 is performed for a GOB 1. At this time, an MC operation 702-0 using the resultant obtained from the ME operation for the GOB 0 is performed simultaneously with the ME operation for the GOB 1. Subsequently, an ME operation 701-2 is performed for a GOB 2. At this time, both an MC operation 702-1 using the resultant obtained from the ME operation for the GOB 1 and a DCT operation 703-0 for the GOB 0 using the resultant obtained from the MC operation for the GOB 0 are performed simultaneously with the ME operation for the GOB 2. Next, an ME operation 701-3 is performed for a GOB 3. At this time, an MC operation 702-2 using the resultant obtained from the ME operation for the GOB 2, a DCT operation 703-1 for the GOB 1 using the resultant obtained from the MC operation for the GOB 1, and a VLC operation 704-0 deciding a quantization value by using the resultant obtained from the DCT operation 703-0 for the GOB 0 are performed simultaneously with the ME operation 701-3 for the GOB 3.

Herein, there is a problem in that the VLC module uses the resultant obtained from the previous operation of the DCT module when controlling a bit rate by controlling a quantization coefficient, etc. in the next operation of the DCT module.

That is, after having completed the VLC operation 704-0 using the resultant obtained from the DCT operation 703-0, the VLC module can transfer a result value for a bit rate control into the DCT module to enable the DCT operation 703-1, but the operation structure shown in FIG. 7 shows that the VLC operation 704-0 and the DCT operation 703-1 are simultaneously performed.

Therefore, with such a normal method, the DCT operation and the VLC operation cannot be correctly performed.

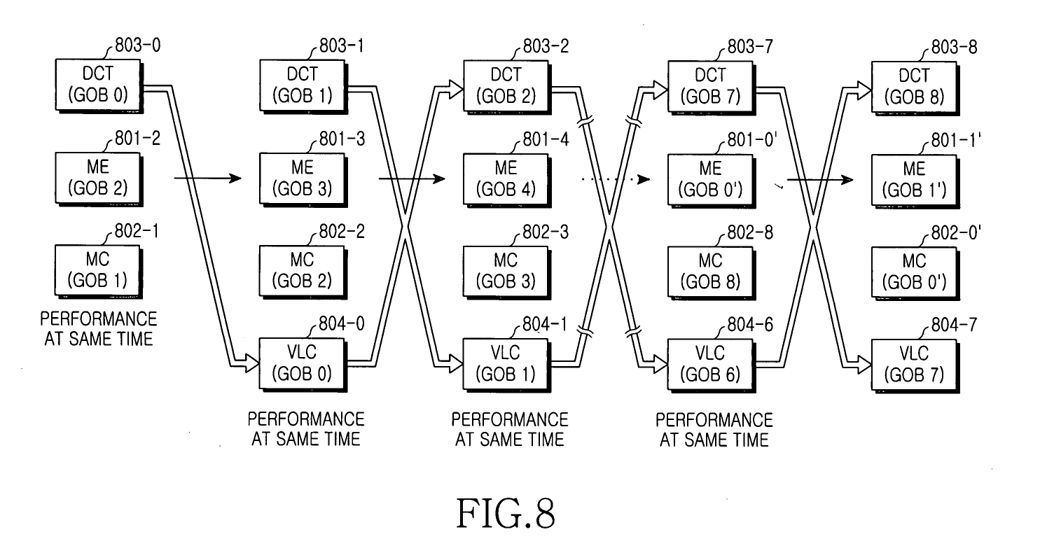

In order to such a problem, the bit rate control of the VLC module according to an embodiment of the present invention is performed in such a manner that a value for a bit rate control obtained from a VLC operation for a Nₜₕ processing block is used as a control value for a DCT operation for a (N+2)^{th} processing block. That is, operations of in a pipeline-type structure can be performed, in which each control value is transferred to every other block as shown in FIG. 8.

FIG. 8 is a diagram illustrating a process of a pipeline-type operation structure for transferring control values between a DCT module and a VLC module according to the present invention.

In the following description, the operation of a pipeline-type operation structure for transferring control values between a DCT module and a VLC module will be explained with reference to FIG. 8. After a DCT operation 803-0 for a GOB 0 has been performed, a VLC operation 804-0 for a GOB 0 is performed to create a first control value by using a result value obtained from the DCT operation 803-0. Then, the first control value is transferred for performing a DCT operation 803-2 for a GOB 2. Also, after a DCT operation 803-1 for a GOB 1 has been performed, a VLC operation 804-1 for a GOB 1 is performed to create a second control value by using a result value obtained from the DCT operation 803-1. Then, the second control value is transferred for performing a DCT operation 803-3 for a GOB 3

In the case in which a current frame N has been processed and then the processing of the next frame N+1 is performed, the control values for DCT operations of the first two GOBs in the next frame N+1 are created through VLC operations 804-7 for the last two GOBs in the current frame N. In FIG. 8, 0′ and 1′ in 801-0′ and 801-1′ are used for indicating GOB of the next frame.

As describe above, the VLC module controls a bit rate by changing a quantization value Q of the DCT module. In the following description, the control operation of the VLC module for changing a quantization value Q of the DCT module will be explained.

In embodiments of the present invention, and in the following examples an operation unit processed by the respective hardware modules is, in a unit of a GOB. However, the invention is not to be limited by the above embodiments, but various operation units, such as an MB (Macro Block), an N×MB, a frame, etc., may be applied to the present invention.

In general, in changing a quantization value for a bit rate control in a video encoder/decoder, a quantization value cannot be freely changed by the VLC module, but can be changed within a range limited according to the previous quantization value. That is, in the case in which the operation unit is a unit of N×MB which is less than the GOB, the change amount of a quantization value is limited to a range between +2 and −2 on the basis of the previous quantization value.

In the case in which the operation unit is a unit of a GOB as described in embodiments of the present invention, it is possible to change a quantization value within a wider range. However, as the difference of the quantization values between operation units becomes greater, the difference in the image qualities becomes greater. That is, when good-quality images and bad-quality images are displayed while overlapping with each other, the entire screen may be produced as a bad-quality image. Therefore, it is necessary to control a change range between the quantization values of the operation units to prevent the difference between the image qualities of the operation units from becoming too large.

According to one embodiment of the present invention, a change range of the quantization value between operation units is as follows.

The quantization value of a current operation unit is limited to a value which is different by a value between +K and −K from the quantization value of a reference operation unit. In addition, the quantization value of a current operation unit is limited to a difference between +M and −M from the quantization value of the previous operation unit.

For example, in the case in which K is ‘4’ and M is ‘2’, the quantization values may be determined as ‘30’, ‘28’, ‘26’, ‘24’, ‘25’, etc. in a sequence of the respective operation units. Herein, for example, ‘26’ has a difference of ‘−4’ from ‘28’ which is the previous operation unit, thereby satisfying the above-mentioned conditions.

In spite of the limited changing range of the quantization values between the operation units as described above, a change between frames may cause a problem. When the change between the quantization values in each frame and the change between the frames are not large, it is reasonable to use a change range of quantization values determined according to the operation units and a control method using the same. However, in the case in which the quantization values in a current frame has a large variation between an upper portion and a lower portion, when a process is shifted to the next frame, the quantization values determined in the lower portion are transferred for the processing of the upper portion, so that the upper portion is processed with unsuitable quantization values.

For example, in the case in which an upper portion has high bit rates but a lower portion has low bit rates in a current frame, when a process is shifted to the next frame, a first operation unit of the next frame is processed with a low bit rate according to the bit rate control method of an operation unit. In this case, since the upper portion of the next frame has high bit rates, a bit rate will continuously increase according to the process, but it is difficult to make a rapid change because of the above-mentioned limitation. Consequently, a first quantization value for a frame exerts a large effect on the generation of the bits in the whole frame, so that when a first quantization value is unsuitably determined, it becomes impossible to obtain a good image.

Therefore, the control of the change range of the quantization values between frames must be performed in a different method from the control method of the change range of the quantization values between the common operation units. In order to control the change range of the quantization values between such frames, it is necessary to determine a tolerable change width for the quantization values and to determine whether or not a bit amount to be generated in a current frame is greater than that of the previous frame.

According to an embodiment of the present invention, a quantization value of a first operation unit in a current frame is estimated by the resultant of VLC operations of the last two operation units in the previous frame. In this case, in order to determine whether or not a bit amount to be generated in the current frame is greater than that of the previous frame, the present invention uses a sum of the absolute difference (hereinafter, referred to as ‘SAD’) generated in an ME process.

That is, the amount of the predicted generation bits is calculated on the assumption that a reference quantization value—a quantization value of the operation unit second prior to a current operation unit—is used in the current operation unit and a SAD value of an operation unit is proportional to a generation bit amount. In this case, when a predicted generation bit amount is greater than an assigned bit amount, a quantization value is determined as a large value although a generation bit amount of the reference operation unit—the operation unit second prior to the current operation unit—is small, thereby reducing a generation bit amount.

Herein, a predicted generation bit amount is calculated as shown in Equation 1.
spentbit_{—}prev:sad_{—}prev=pred:sad_{—}cur∴pred=(spentbit_{—}prev*sad_{—}cur)/sad_{—}prev (1)
where ‘spentbit_prev’ represents a generation bit of a reference operation unit, ‘pred’ represents a predicted generation bit of a current operation unit, ‘sad_cur’ represents a SAD value of the current operation unit, and ‘sad_prev’ represents a SAD value of the reference operation unit.

As described above, quantization values of a new frame is estimated using a predicted generation bit rate calculated by Equation 1. Therefore, a change width of the quantization values can increase in comparison with the conventional method using only the operation units for the decision of the quantization values.

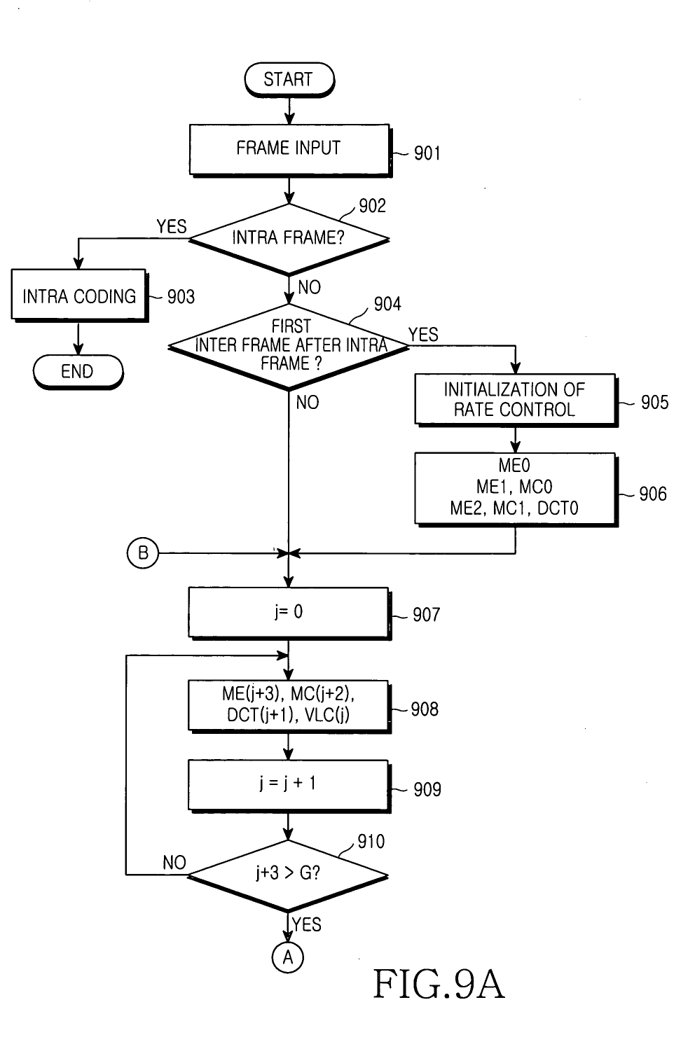

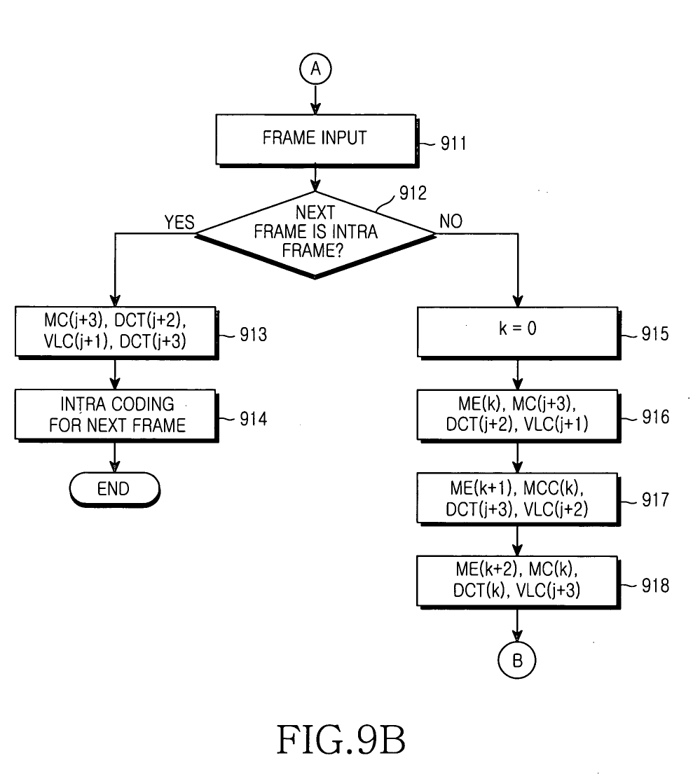

FIGS. 9A and 9B are flowcharts showing an embodiment of an encoding method for a video encoder having a pipeline-type operation structure according to the present invention.

As shown in FIG. 9A and FIG. 9B, according to an encoding method for a video encoder having a pipeline-type operation structure in accordance with the present invention, first, a frame is input (step 901).

Then, it is determined whether or not the input frame is an intra frame (step 902). Herein, the reason for making such a determination is that the present invention provides a method regarding inter frames, in which the entire frames are not stored and only the difference between the specific frames is stored taking into consideration the fact that frames in the vicinity of a specific frame are very similar to each other. That is, intra frames each of which are wholly compressed are not an object of the present invention.

Next, when it is confirmed that the input frame is an intra frame, the intra frame is coded (step 903), and the process ends.

When the input frame is not an intra frame, it is determined whether or not the input frame is a first inter frame input after an intra frame (step 904). In step 904 it is determined whether or not it is necessary to undergo initializing processes. When the input frame is a first inter frame input after an intra frame, an initializing process for a bit rate control (step 905) and an initializing process for performing operations in a pipeline-type operation structure (step 906) are proceeded.

In the following description, the initializing process for a bit rate control (step 905) will be explained in more detail.

In order to initialize a bit rate control, first, the number of bits generated in the previous frame and an average quantization value of the previous frame are input. Then, the new object bit rate is assigned. The new object bit rate is calculated by Equation 2.
New object bit rate=(Whole bit rate−Bit rate obtained through accumulation thereof up to a present time)/Number of remaining frames (2)

Next, when the new object bit rate is assigned, an initial quantization value is obtained and then the initializing process for a bit rate control is ended. The initial quantization value is calculated as shown in Equation 3.
Initial quantization value=Average quantization value of the previous frame×(1+global) (3)
where ‘global’ is obtained by ‘(number of generated bits in the previous frame—number of new object bits)/(2×number of new object bits).

In the following description, an initializing process for performing operations in a pipeline-type operation structure (step 906) will be explained in more detail.

First, an ME process for a first operation unit (for example, GOB 0) is performed. Then, an ME process for a second operation unit (for example, GOB 1) and an MC process for the first operation unit are performed. Next, an ME process for a third operation unit (for example, GOB 2), an MC process for the second operation unit, and a DCT process for the first operation unit are performed.

After the initial processes of steps 905 and 906 are performed as described above, an ME process for a (j+3)^{th} operation unit, an MC process for a (j+2)^{th} operation unit, a DCT process for a (j+1)^{th} operation unit, and a VLC process for a j^{th} operation unit are performed in a pipeline-type operation structure (steps 907, 908, 909, and 910), while the value of ‘j’ increases by ‘1’ until the last operation unit of a current frame is processed.

Herein, in order to determined whether or not an operation unit is the last operation unit of the current frame (N), the result value obtained by subtracting 1 from the total number of operation units included in a frame is set as ‘G’, and when ‘j+3’ is greater than ‘G’, it is determined that a processing process of a current frame has been ended and then the next frame (N+1) is input (step 911).

Next, it is determined whether or not the input next frame (N+1) is an intra frame (step 912). This determination is performed in order to end the process according to the present invention on the current frame (N) when the next frame (N+1) is an intra frame. This may be applied to the case in which all of the frames are ended, too.

When the input next frame (N+1) is an intra frame, no additional ME operation is performed, and MC and DCT processes are performed until the last operation unit of the current frame (step 913) is processed. At this time, it is unnecessary to perform a VLC process for the last operation unit and the operation unit previous to the last operation unit, because there is no object to which quantization values determined through the VLC process for such operation units are transferred.

After the operation of the current frame has been ended in step 913, an intra coding is performed with respect to the inputted next frame (step 914).

N is a current frame and (N+1) is a next frame of N. Herein, the index of GOB of N is j and the index of GOB of N+1 is k. Meanwhile, when the inputted next frame (N+1) is not an intra frame k is set to Ø in step 915, and an ME process for a first operation unit (for example, GOB 0) of the next frame (N+1), an MC process for a (j+3)^{th} operation unit of the current frame, a DCT process for a (j+2)^{th} operation unit of the current frame, and a VLC process for a (j+1)^{th} operation unit of the current frame are performed (step 916). Next, an ME process for a second operation unit (for example, GOB 1) of the next frame (N+1), an MC process for a first operation unit of the next frame (N+1), a DCT process for a (j+3)^{th} operation unit of the current frame, and a VLC process for a (j+2)^{th} operation unit of the current frame are performed (step 917). Subsequently, an ME process for a third operation unit (for example, GOB 2) of the next frame (N+1), an MC process for a second operation unit of the next frame (N+1), a DCT process for a first operation unit of the next frame (N+1), and a VLC process for a (j+3)^{th} operation unit of the current frame are performed (step 918).

As described above, when the process for the portion overlapped between the current frame and the next frame has been ended, step 907 is processed, in which normal operations are performed in the pipeline-type operation structure.

In the above-mentioned steps 917 and 918, the VLC process for the (j+2)^{th} operation unit and the VLC process for the (j+3)^{th} operation unit are performed to decide the quantization values for the first and second operation units of the next frame (N+1), respectively. When frames changes as described above, the control of the quantization values is preformed through the following process.

First, the amount (A) of the bits assigned for the operation units up to a present time is calculated.

The amount (B) of the predicted generation bits in a current operation unit, that is, in a first or a second operation unit of a new frame, is calculated. The value of ‘B’ is obtained by Equation 1 as described above.

Also, the amount (C) of the assignment bits actually generated up to the current operation unit is calculated. Herein, ‘C’ is a sum of ‘B’ and a ‘bit amount generated and accumulated up to the previous operation unit’.

After this, when a comparison shows that ‘A’ is greater than ‘C’, a quantization value is reduced. In contrast, when ‘A’ is less than ‘C’, a quantization value is increased.

The method according to the present invention can be realized by a program and can be stored in a recording medium (such as a CD ROM, a RAM, a floppy disk, a hard disk, an optical and magnetic disk, etc.) in a format that can be read by a computer.

According to the present invention as described above, since the video processing apparatus including the hardware modules according to the functions that process the data are processed by the hardware modules operated in parallel to each other instead of being processed by the operation unit, the idle operations of the hardware modules are reduced, so that there is an advantage in that resources can be efficiently utilized.

Also, according to the method of the present invention, a change range of the quantization values including a reference range is provided for the bit rate control of the DCT module, which may cause a problem on an operation in a pipeline-type operation structure, so that the bit rate control can be efficiently performed.

Also, in the bit rate control according to the present invention, SAD values of the operation units are used for the bit rate control between the frames, so that there is an advantage in that it is possible to widen the range of the bit rate change when the process is shifted from one frame to another frame.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

That is, while the embodiments of the present invention has been described with respect to a video encoder, the scope of the invention is not to be limited to a video encoder, but can be applied to a video decoder also within the knowledge of those skilled in the art.

1. A pipeline-type operation method for a video processing apparatus including a plurality of hardware modules, the method comprising the steps of:
1) constructing a plurality of hardware modules according to functions required to process video;
2) arranging the hardware modules according to a sequence of input data flow, and inputting a first predetermined unit of data into a first hardware module from among the arranged hardware modules;
3) transferring processed data from the first hardware module to a second hardware module when the predetermined unit data input into the first hardware module has been processed, and receiving a next predetermined unit of data;
4) repeating step 3, in which each input data is processed by the hardware modules according to a sequence of the hardware modules, until all of the hardware modules are operated;
5) receiving and processing data processed in a previous step by the previous hardware module in a sequence of data flow by each of the hardware modules; and
6) repeating step 5 until all of the predetermined units of data to be input have been processed.

2. The method as claimed in claim 1, wherein each of the plurality of hardware modules are independently operated.

3. A method for controlling a bit rate in a video processing apparatus which comprises a plurality of hardware modules including a variable length coding (VLC) module and has a pipeline-type operation structure, the method comprising the steps of:
1) independently operating each of the hardware modules including the VLC module in the pipeline-type structure;
2) transferring into the VLC module a coding result of a predetermined unit of data second prior to a current predetermined unit of data in a specific sequence so that the VLC module determines a quantization value for the current predetermined unit of data which is to be coded in the specific sequence; and
3) determining a quantization value required for coding by means of a coding result transferred in step 2, and transferring the determined quantization value to a coding course for a predetermined unit of data subsequent to the data in the specific sequence.

4. The method as claimed in claim 3, wherein, when the determination of the quantization value is preformed in a frame, the determination of the quantization value is controlled to change within a predetermined range with reference to a quantization value determined through coding for the predetermined unit of data second prior to the current predetermined unit of data in the specific sequence, and a quantization value determined through coding for the predetermined unit data previous to the current predetermined unit of data in the specific sequence.

5. The method as claimed in claim 3, wherein, when the determination of the quantization value is preformed between frames, the determination of the quantization value is controlled through a prediction of a complexity of predetermined unit of data input in the specific sequence, in which the prediction of the complexity is obtained by using a rate between a SAD (Sum of Absolute Difference) value of the predetermined unit data second prior to the current predetermined unit of data in the specific sequence and a SAD value of the predetermined unit data previous to the current predetermined unit of data in the specific sequence.

6. The method as claimed in claim 5, wherein, the rate between a SAD (Sum of Absolute Difference) value of the predetermined unit of data second prior to the current predetermined unit of data in the specific sequence and a SAD value of the predetermined unit data previous to the current predetermined unit of data in the specific sequence is calculated by:
spentbit_{—}prev:sad_{—}prev=pred:sad_{—}cur∴pred=(spentbit_{—}prev*sad_{—}cur)/sad_{—}prev
where ‘spentbit_prev’ represents a generation bit of the predetermined unit data second prior to the data in the specific sequence, ‘pred’ represents a predicted generation bit of predetermined unit data input in the specific sequence, ‘sad_cur’ represents a SAD value of predetermined unit data input in the specific sequence, and ‘sad_prev’ represents a SAD value of the predetermined unit of data second prior to the data in the specific sequence.

7. The method as claimed in claim 6, wherein, the predicted generation bit of the predetermined unit of data input in the specific sequence is calculated by estimating a predicted generation bit of a predetermined unit of data input in the specific sequence, and a quantization value for coding of the predetermined unit of data input in the specific sequence changes according to a difference between the predicted generation bit and a bit assigned to the predetermined unit of data input in the specific sequence.

8. The method as claimed in claim 7, wherein, the quantization value decreases when a sum of the predicted generation bit of the predetermined unit of data input in the specific sequence and a generation bit accumulated up to a present time is greater than an assignment bit accumulated until the predetermined unit of data input in the specific sequence.

9. The method as claimed in claim 7, wherein, the quantization value increases when a sum of the predicted generation bit of the predetermined unit of data input in the specific sequence and a generation bit accumulated up to a present time is less than an assignment bit accumulated until the predetermined unit of data input in the specific sequence.
